(19) United States
(12) Patent Application Publication
(10) Pub. No.: US 2025/0378478 A1
(43) Pub. Date: Dec. 11, 2025

(54) CENTROID-BASED MACHINE LEARNING ITEM RANKING WITHIN AN EMBEDDING SPACE

(71) Applicant: Expedia, Inc., Seattle, WA (US)

(72) Inventor: Lamya Moutiq, London (GB)

(21) Appl. No.: 18/737,796

(22) Filed: Jun. 7, 2024

(51) Int. Cl. G06Q 30/0601

(52) U.S. Cl. CPC G06Q 30/0631; G06Q 30/0625; G06Q 30/0633

(57) ABSTRACT

Systems and methods for a two-part recommendation system wherein a non-personalized item-to-candidate item list is generated without personalization and the items within the corresponding candidate list may be ranked in order to personalize that list to the particular user. In an embodiment, ranking occurs based on a distance function between individual items in the list and the reference item, such as a distance between the items within an embedding space that represents relevant features of items as vectors in latent space. Accordingly, ranking by a candidate ranker can select which items in the candidate list are most pertinent and personalized to the user at a present time. Because ranking can require significantly fewer resources than generating the candidate list, this two-part system can enable real-time recommendations that are personalized to the user.

### BACKGROUND

Online platforms and websites provide users with access to a multitude of items for browsing, viewing, and purchasing. Users of travel booking websites may interact with travel-related items (e.g., hotel listings, flights), which in turn may prompt the presentation of additional and/or similar items that may help users in refining their search. Recommendation systems play a pivotal role in presenting a user with recommended items on these online platforms and websites. In some cases, recommendation systems may take into account a user’s preferences and behaviors in tailoring recommended items.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a schematic block diagram of an example network environment in which a recommendation system may operate, according to various aspects of the present disclosure.

FIG. 2A is an example data flow process in which the recommendation system may operate, according to various aspects of the present disclosure.

FIG. 2B is an example data flow process in which the candidate ranker of the recommendation system may be trained, according to various aspects of the present disclosure.

FIG. 3 illustrates a graphical representation of an embedding space in which centroid determination may be executed by the recommendation system 106 (or the candidate ranker 110), according to various aspects of the present disclosure.

FIG. 4 illustrates a graphical representation of an embedding space in which distance calculations utilizing a determined centroid may be executed by the recommendation system 106 (or the candidate ranker 110), according to various aspects of the present disclosure.

FIG. 5 is a block diagram illustrating components of an example computing system that can be used to implement the various systems and methods described herein.

FIG. 6 is flow diagram showing an example routine for providing personalized ranked recommendations to a user, according to various aspects of the present disclosure.

### DETAILED DESCRIPTION

Generally described, aspects of the present disclosure relate to efficient mechanisms for selecting additional items related to a first item, such as for use in network-based recommendation systems. Simple recommendation systems—such as those that rely on defined correspondence between items—can suffer from low accuracy, in that they often recommend items that are not of interest to a user. Moreover, static item correspondence generally does not account for personalization based on the particular user at interest. More complex recommendation systems—such as those based on machine learning techniques—can provide more accurate recommendations and account for personalization; however, those techniques are often slow or computationally complex, impairing real-time recommendations. Embodiments of the present disclosure address these challenges by providing a highly efficient, highly accurate recommendation system suitable for many real-time applications. More specifically, embodiments disclosure herein provide for a two-part recommendation system, whereby a non-personalized item-to-candidate item list is generated without personalization (e.g., as a periodic, non-real-time process) and whereby when an item is selected by a user (a “reference item”), items within the corresponding candidate list can be ranked in order to personalize that list to the particular user. In one embodiment, ranking occurs based on a distance function between individual items in the list and the reference item, such as a distance between the items within an embedding space that represents relevant features of items as vectors in latent space. Accordingly, ranking can select which items in the candidate list are most pertinent to the user at a present time. Because ranking can require significantly fewer resources than generating the candidate list, this two-part system can enable real-time recommendations that are personalized to the user.

Embodiments of the present disclosure may be particularly suited to applications in spaces concerning highly distinguishable items (e.g., where each item is unique and represents non-commoditizable characteristics that may be of interest to a user), as the uniqueness of items in such a space can present difficulties to other recommendations systems. Embodiments of the present disclosure may be further suited to applications in spaces concerning dynamic inventory—where a given item may or may not be available at a given time, thus inhibiting less sophisticated recommendation systems. One example of such a space is in travel recommendations, such as recommendations for lodging.

Aspects of the present disclosure relate to a two-part recommendation system recommendation system that incorporates personalized features into the ranking of items in a candidate list. Embodiments of the present disclosure are illustratively described with respect to property items, alternatively referred to as lodging items, which refer to lodging accommodations acquirable by a traveler (including but not limited to hotel rooms, motel rooms, short term housing, condominium, or apartment rentals, hostels, and the like). However, aspects of the present disclosure may be applied to other types of items. Thus, reference to property or lodging items should be viewed as illustrative.

In a first part, the recommendation system as described herein may comprise a candidate generator. In the context of lodging recommendations, candidate generator may narrow down a multitude of property items to a subset of recommendable items (“candidate items”). This process may be accomplished via filtering methods, such as collaborative filtering. To conserve resources and cut down on processing time, the candidate generator may generate a list of candidate items offline, such as via a lookup table, and the like. For example, the results performed from periodic collaborative filtering methods on the world of potential items may be stored within a lookup table for the candidate generator to access offline. For example, for each item, the lookup table may store items considered similar to the item. This process may be performed with reference to the reference item. For example, when a reference item is selected by a user, the candidate generator may access the lookup table to quickly access a certain number of items to include in the candidate list (e.g., 100 properties).

In response to the generation of a candidate list by the candidate generator, the candidate list may be passed to the candidate ranker for personalized ranking. The candidate ranker may comprise the second part of the two-part recommendation system. At this stage, the candidate generator may rank the candidate list to personalize the list to the user. This process may be accomplished via the integration of personalized features into a ranking model.

Personalized features or information as utilized herein may refer to information centered around a user that may not necessarily change with the present circumstance. For example, personalized information may include user behavior, past interactions with items, preferences, trends, deviations from certain items, and/or any other historical information associated with a user. This may be distinguished from contextual features that may refer to any information that is circumstantial or situational information. For example, in the context of query searching (e.g., searching for hotels), contextual information may include user-related contextual information such as a user’s location or a device type. Personalized information may be accessed by the candidate ranker in the form of historical information pertaining to a user. Previous user interactions (e.g., clicks within a session) may be utilized to map a user’s personal “journey” with reference to items within a database. For example, the candidate ranker may identify a certain item that a user clicked and viewed over multiple sessions. Each item (e.g., property listing) may be associated with a location in an embedding space (an “embedding”), that may be represented by a vector. An embedding space as used herein may refer to an n-dimensional space that contains item vectors in such a way that similar items are located relatively close to each other, while dissimilar items are located relatively far apart. The system as described herein may utilize the spatial distance and other calculations using item embeddings to integrate personalization into the ranking process. For example, by determining centroids (e.g., an average of proximate embeddings), the candidate ranker may aggregate a user’s interest into a representative central point. These centroids may be used to determine various features for input into the ranker models. For example, centroids may be compared against the candidate list of items from the candidate generator. Additionally, or alternatively, the centroids may be compared against a location in the embedding space associated with the reference item. Personalized features may be input into a model or algorithm by the ranker, to rank each item of the list of candidate items. For example, the rankings of each item of the candidate list may be based at least in part on a distance between the item and the centroid. In response to the ranking of all candidate items, the recommendation system may output a personalized ranked list of items for output to the user.

Recommendation system may be trained prior or during the processes outlined herein. Specifically, models utilized by the recommendation system may be trained such that the models may be configured to output a ranked set of items based at least in part on centroid distances (e.g., the distance between individual candidate items and the centroid). Training data fed into the model(s) may consist of sample sessions ending with a user booking a particular property. This process may train the model(s) accessed by the recommendation system to predict items that will likely be purchased, based on the user’s historical data (e.g., items previously viewed).

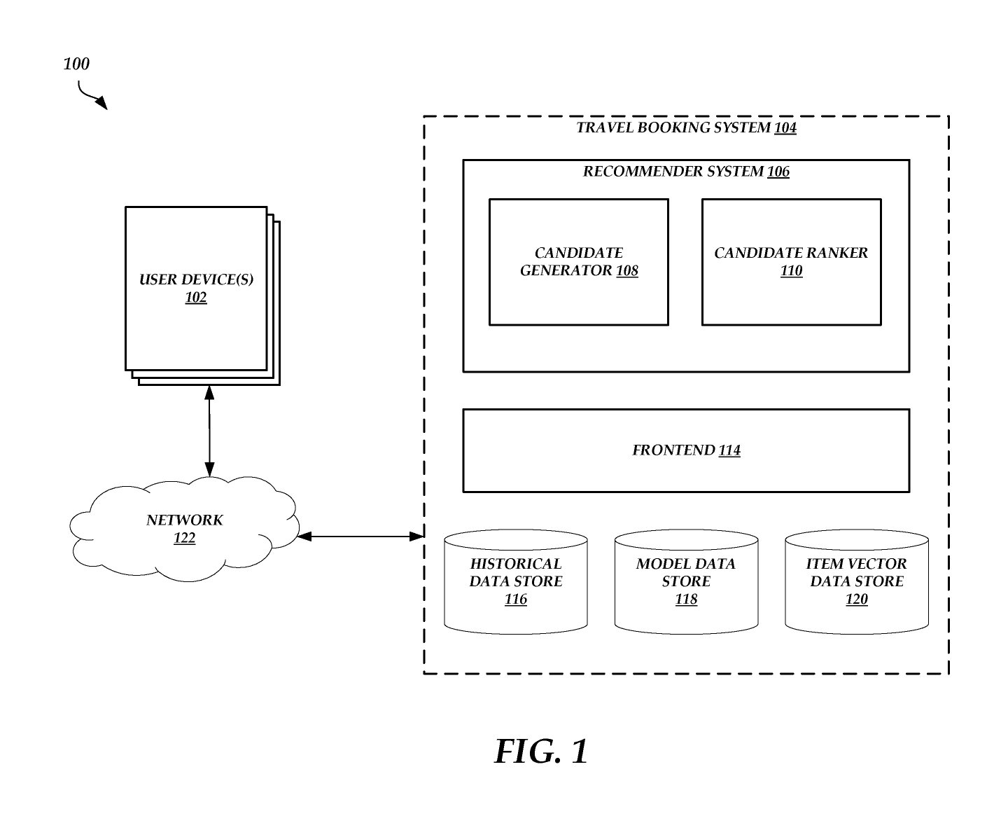

FIG. 1 is a schematic block diagram of an example network environment 100 in which embodiments of the present disclosure may be implemented by a recommendation system 106 of a travel booking system 104. The recommendation system 106 may be configured to provide item recommendations to be output to a user accessing an experience, such as in the frontend 114.

As shown in FIG. 1, the network environment 100 includes user device(s) 102 (hereinafter referred to as “user device 102” for ease of reference), recommendation system 106 (including candidate generator 108, candidate ranker 110), frontend 114, historical data store 116, model(s) 118 (hereinafter referred to as “model data store 118” for ease of reference), item vector data store 120, and network 122. The components of computing network environment 100 may be communicatively coupled via network 122. In addition, network 122 may connect the user device 102 to the travel booking system 104 and various components of the travel booking system 104. The network environment 100 and components of network environment 100 can include various hardware components and software components and can provide functionality as described further herein.

In various aspects, communications among the various components of the example network environment 100 and travel booking system 104 may be accomplished via any suitable device, systems, methods, and/or the like. For example, the recommendation system 106 may communicate with the user device 102, frontend 114, any of the datastores via any combination of the network 122 or any other wired or wireless communications networks, method (e.g., Bluetooth, WiFi, infrared, cellular, and/or the like), and/or any combination of the foregoing or the like. As further described below, network 122 may comprise, for example, one or more internal or external networks, the Internet, and/or the like.

Further details and examples regarding the implementations, operation, and functionality of the various components of the recommendation system 106 of travel booking system 104 are described herein in reference to various figures.

The network 122 of the network environment 100 can include any appropriate network, including wired network, wireless network, or combination thereof. For example, network 122 may be a personal area network, local area network, wide area network, cable network, satellite network, cellular network, or any other such network or combination thereof. As a further example, the network 122 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 122 may be a private or semi-private network, such as a corporate or university intranet. The network 122 may include one or more wireless networks, such as a Global System for Mobile Communications (GSM) network, a Code Division Multiple Access (CDMA) network, a Long-Term Evolution (LTE) network, C-band, mmWave, sub-6GHz, or any other type of wireless network. The network 122 can use protocols and components for communicating via the Internet or any of the other aforementioned types of networks. For example, the protocols used by the network 122 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 122 can represent a network that may be local to a particular organization, e.g., a private or semi-private network, such as a corporate or university intranet. In some implementations, devices may communicate via the network 122 without traversing an external network, such as the Internet. In some implementations, devices connected via the network 122 may be walled off from accessing the Internet. As an example, the network 122 may not be connected to the Internet. Accordingly, e.g., the user device 102 may communicate with the recommendation system 106 directly (via wired or wireless communications) or via the network 122, without using the Internet. Thus, even if the network 122 or the Internet is down, the recommendation system 106 may continue to communicate and function via direct communications (and/or via the network 122).

User device 102 may be used to access various components of the travel booking system 104 over the network 122. User device 102 illustratively correspond to any computing device that provides a means for a user or admin to interact with components of the travel booking system 104 (e.g., recommendation system 106, frontend 114, data stores). For example, a user, with user device 102, may access the recommendation system 106 to provide item recommendations for display in the frontend 114. In some examples, the frontend 114 may be implemented on user device 102. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, and the like. In some implementations, user device 102 can access a cloud provider network via the network 122 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

To facilitate interaction between the travel booking system 104 and the user devices 102 via the network 122, the network system 104 includes a frontend 114. Frontend 114 may include any presentation layer (e.g., experience layer) such as a user-facing interface or platform through which a user of the user device 102 may access and interact with travel-booking services. In some implementations, the frontend 114 may be configured to render an “experience” on a user device 102 that a user may interact with to access the travel-booking services. For example, the frontend 114 may include a website on a browser, a mobile application, a tablet application, and the like. The frontend 114 may provide access to a range of travel-booking services, such as a search service for flights, hotels, lodging, car rentals, cruises, and other travel-related services, providing recommendations, creating itineraries, etc. The frontend 114 may display a user interface, e.g., a webpage, relating to a reference item. For example, in the case that the reference item is a particular property listing, the user interface of the frontend 114 may include information such as location, supplier name, amenities (e.g., breakfast availability, pool, pet friendly, WiFi, spa, smoking/no-smoking), price, available dates for booking, nearby attractions, travel options, and the like. A user interface of the frontend 114 may also display other items, such as related or recommended items, in an additional area of the webpage for the user to access. The systems and methods described herein may relate to the generation of recommended items to be displayed in the user interface relating to the reference item.

In some implementations, the experience provided by the frontend 114 may vary depending on the user device 102. For example, a website experience on a laptop (via a web browser, etc.) may be different from the same website opened on a browser of a mobile device. In this example, although the content of the website may be the same between both experiences, the layout of the content of the website may vary between the devices. In some cases, the frontend 114 may contain advertisements, links, and other promotional content that is embedded within the frontend 114 for users to interact with. In addition, embedded content and/or links to third-party websites or services may be included within the frontend 114.

In response to interaction between a user of the user device 102 and the frontend 114, the travel booking system 104 may capture historical data. As shown in FIG. 1, travel booking system 104 includes historical data store 116. Historical data store 116 may store information that is personalized to a user. For example, historical data store 116 represents information relating to a user’s behavior, trend, patterns, deviations, actions. Historical data store 116 may include any information collected about a user interacting with the frontend 114. For example, historical data store 116 may include a log of user activity with various items associated with an experience (e.g., user interface) in the frontend 114. For example, in the context of travel-booking websites, the user may interact with various properties, hotels, miscellaneous items for available for purchase (collectively “items”). Historical data store 116 may store any information related to a user’s interaction with items (“historical items”), such as a list of properties interacted with, timestamps, click counts, click locations, time spent viewing each page/item, search strings, number of sessions, etc.

Historical data store 116 may be stored at a remote location and accessible via the network 122. In some implementations, historical data store 116 may be accessible through one or more online services (e.g., website(s), application(s), API(s), or the like) such as via network 122. The historical data store 116 can be stored on multiple computing systems. In some implementations, the historical data store 116 can be stored on one or more remote servers and accessible via network 122. In some implementations, the historical data store 116 may be stored on one or more servers in multiple locations and accessible via network 122.

Model data store 118 may store any algorithm, program, generative language model, artificial intelligence (AI) model (such as a machine learning (ML) model, deep learning model, neural network, etc.) to be accessed by the recommender system 106. In some embodiments, the ML model, such as model data store 118, is a gradient boosting mode or tree (e.g., LightGBM, XGBoost), and the like. The recommendation system 106 (or components of the recommendation system 106). The model data store 118 may be stored in a database or data store in the travel booking system 104 and accessible via the network 122.

Item vector data store 120 may store information relating to items of the travel booking system 104. Each vector stored of the item vector data store 120 may correspond to an item. As used herein, an item may include a property (e.g., hotel, rental, condo, resort, spa, chalet, cabin, villa), a car, a flight, an activity, a package, or any other listing that is associated with the travel booking system 104. Recommendations for lodging (e.g., property items) will be utilized herein as a main example, although the processes described may be extended to any type of item associated with the travel booking system 104. In addition, each item may be associated with a location in an embedding space, and as such, may be represented by a vector to be stored in the item vector data store 120.

As used herein, the embedding space may refer to a n-dimensional space that contains item embeddings, represented by vectors, in such a way as to spatially represent the relationships among the items. For example, items that are similar (e.g., similar location, similar price, similar rating) may be represented in the embedding space at locations that are proximate to each other. Items that are dissimilar may be represented in the embedding space at locations that are distant from each other. Items accessed by components in the travel booking system 104 may all be represented as vectors in the item vector data store 120 and may be associated with a location in the embedding space.

In some embodiments, items (or embeddings) within the embedding space may be generated in a neural network architecture and based on a combination of data. For example, relevant data includes user clicks, property attributes (e.g., property type, star rating, average user rating), amenity information (e.g., free Wifi, free breakfast, pool), and geographic information. Each one of these may be represented in the embedding space as a separate embedding: a click embedding, an amenity embedding, and a geographical embedding. Each of these features of the same item may be embedded separately within the embedding space and then concatenated such that the location of the item includes the feature information. Once combined, the location associated with the property in the embedding space may be an average corresponding to each of combined embeddings. Each property accessed by the recommendation system 106 may be enriched with other sources of data, and may represent any other combination of features or information.

To generate and rank recommendations, the travel booking system 104 may access the recommendation system 106. The recommendation system 106 is a two-part recommendation system configured to generate and provide ranked item recommendations to be presented to a user. The recommendation system 106 may access any component of travel booking system 104, such as the historical data store 116, model data store 118, item vector data store 120, etc. to provide ranked items to a user, such as via the frontend 114.

As noted herein, the recommendation system 106 may generate and rank candidate items in a two-step process. The first part of the recommendation system 106 includes a candidate generator 108 configured to generate a non-personalized list of candidate items. To generate a non-personalized candidate item list, the candidate generator 108 may access a database of items, such as properties (e.g., hotels, rentals) associated with the travel booking system 104. Each item of the database may be represented as a vector and stored in the item vector data store 120. The candidate generator 108 may select items to include in the candidate list based on filtering methods, such as collaborative filtering. This filtering process may be performed by the candidate generator offline to conserve resources and cut down on processing time. As such, the results performed from periodic collaborative filtering methods on the world of potential items of the item vector data store 120 may be stored within a lookup table for the candidate generator 108 to access quickly.

Once generated by the candidate generator 108, the candidate list may be provided to the candidate ranker 110 to be ranked. The candidate ranker 110 may access other components of the travel booking system 104 to complete the ranking of the candidate items, such as the historical data store 116, the model data store 118, and the item vector data store 120. To rank the candidate list based on user personalization, for example, the candidate ranker 110 may integrate historical data store 116. Historical data store 116 may include historical items that a user has interacted with. To consolidate historical data store 116 as a representation of the user’s personalized interest, the candidate ranker 110 may determine a centroid. In an embodiment, a centroid may represent an average of the historical items that a user has interacted with. To rank the candidate list based on user personalization, the candidate ranker 110 may further calculate distances between each candidate item and the centroid (e.g., in the embedding space). These distances may convey a user’s personalized interest (via the centroid) in relation to the candidate items. The candidate ranker 110 may determine a variety of distance measurements between the centroid and other locations in the embedding space. Distance measurements or calculations may include cosine distance, Euclidian distance, hamming distance, Manhattan distance, Minkowski distance, Chebyshev distance, Jaccard distance, haversine distance, Sørensen-Dice distance, etc. Distance calculation and other information can be later be input into a ranking model to personalize the ranked list of items. The processes to generate and rank items based on user personalization by the recommendation system 106 will be described in detail with reference to the following figures.

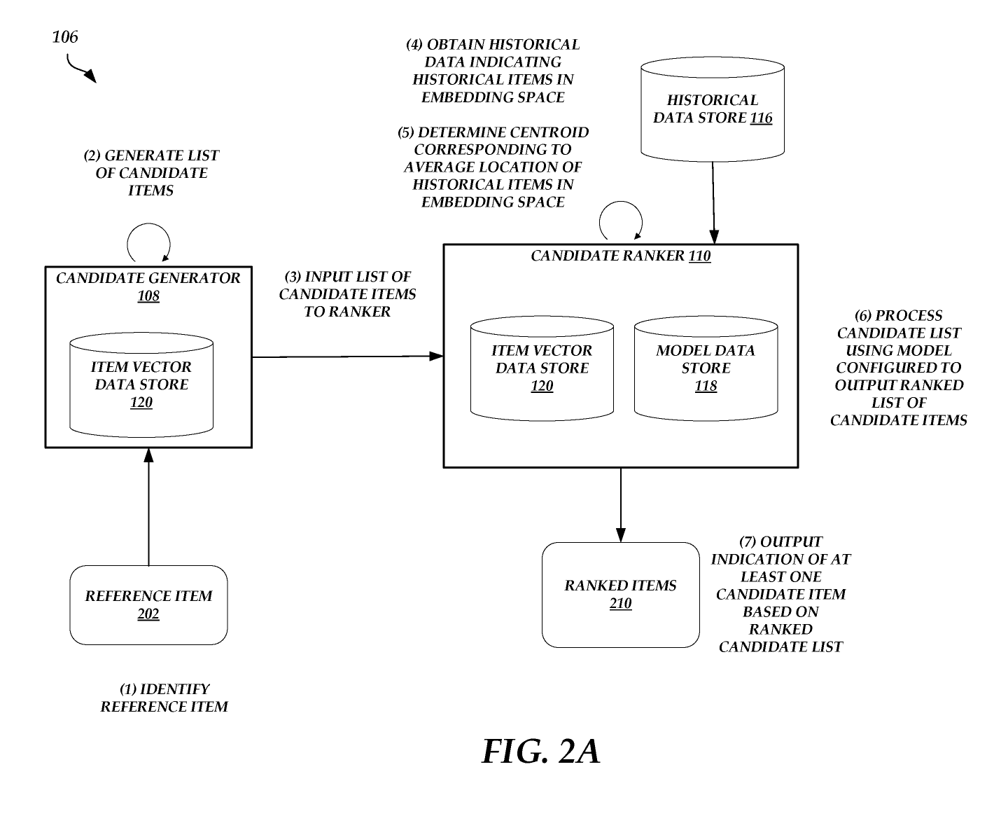

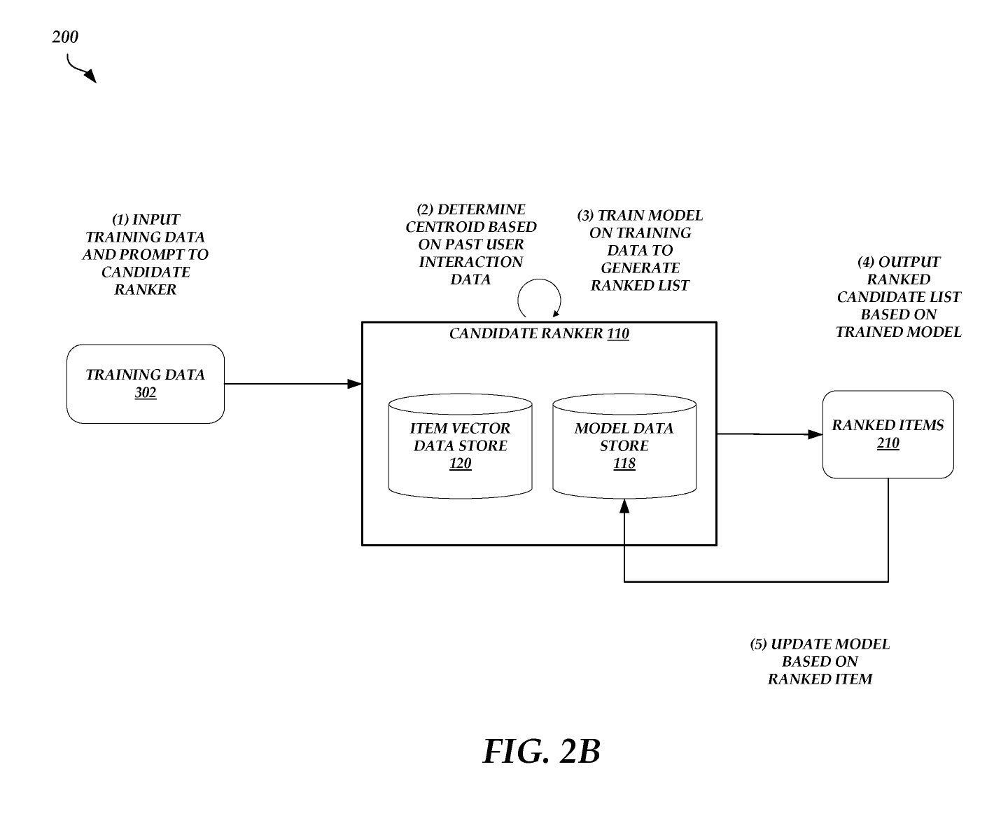

FIG. 2A is a block diagram of the recommendation system 106 and example data flow process in which the recommendation system 106 may operate, according to various aspects of the present disclosure. The two-part recommendation system 106 may generate a candidate list of items to be ranked according to personalized information of a user. In a non-limiting embodiment, the recommendation system 106 may be configured to provide recommendations to a user viewing a reference item 202 in an experience (e.g., a hotel listing on a website) in the frontend 114. The recommendations presented to a user viewing the reference item 202 may be generated based on processes executed by the recommender system 106.

At (1), a reference item 202 may be identified. The reference item 202 may include any item associated with the travel booking system 104. For example, the reference item 202 may include a property (e.g., hotel, rental, condo, resort, spa, chalet, cabin, villa), a car, a flight, an activity, a package, or any other listing. The reference item 202 may be any item related to a travel-booking website that is available for a user to view, book, rent, purchase, etc. in the frontend 114. The reference item 202 may be associated with a location within an embedding space, and stored as a vector within the item vector data store 120.

The processes carried out by the recommendation system 106 may be triggered by an action of a user of the frontend 114. A trigger event may include when a user, via the frontend 114, clicks or accesses the reference item 202. For example, the user may search for a particular item via a search function in the frontend 114 (e.g., hotels in Palermo, Sicily). Upon viewing the results, the user may then select one particular property, which may be the reference item 202. This event may trigger the recommendation system 106 to access, obtain, or otherwise identify the reference item 202.

At (2), the candidate generator 108 (of the recommendation system 106) may receive the reference item 202 and generate a list of candidate items. To generate the candidate list of items, the candidate generator 106 may access all possible items, such as items stored as vectors in the item vector data store 120. The item vector data store 204 may store all possible candidate items, and may include any item associated with the travel booking system 104. For example, the item vector data store may store a listing or representation of a property (e.g., hotel, rental, condo, resort, spa, chalet, cabin, villa), a car, a flight, an activity, a package, or any other listing that is associated with the travel booking system 104.

The candidate generator 108 may narrow down a set of millions of items stored in the item vector data store 120 to a list of hundreds of candidate items, for example. The candidate generator 108 may access any algorithm, program, generative language model, artificial intelligence (AI) model (such as a machine learning (ML) model, deep learning model, neural network, etc.) configured to generate a candidate list of items. For example, the candidate generator 108 may access a collaborative filtering model, a semantic embedding model, a two-tower model, and the like. In some embodiments, the candidate generator 108 may access a hybrid model that combines the processes of any of the above-referenced models above. The candidate generator 108 may generate any number of candidate items to be included in the list of candidate items.

In some embodiments, the processes carried out by the candidate generator 106 may be performed asynchronously or offline. As noted herein, asynchronous or offline performance may refer to a process that is pre-computed, rather than computed in response to a user request (e.g., for recommended items). For example, the candidate generator 108 may pre-compute potential candidate items associated with a reference item. This may be accomplished via collaborative filtering models performed by the candidate generator 108 in an offline process. Results of the pre-computed candidate items may be stored by the candidate generator 108 in a lookup table. The candidate generator 108 may operate offline to preserve computing resources and to reduce latency. In addition, any offline lookup tables may be refreshed periodically. For example, for a certain reference item 202, the candidate generator 106 may access the lookup table to retrieve a number of candidate items that correspond to the reference item 202 that have already been curated by a collaborative filtering process carried out online (e.g., monthly). This approach allows the candidate generator 108 to quickly retrieve a manageable set of candidate items related to the reference item 202 to be ranked by the candidate ranker 110. In response to the generation of the list of candidate items, at (3), the candidate generator 108 may input the list of candidate items to the candidate ranker 110. In some embodiments, the candidate generator 108 may also input information associated with the candidate items. For example, in addition to generating the list of candidate items, the candidate generator 108 may generate a prediction score associated with each candidate item. The prediction score may include a predicted ranking of each candidate item. Prediction scores and any other relevant candidate item information may be passed to the candidate ranker 110 for utilization in the ranking of the candidate items.

As noted herein, embodiments disclosure herein provide for a two-part recommendation system, whereby a non-personalized item-to-candidate item list is generated without personalization (e.g., as a periodic, non-real-time process) by the candidate generator 108 at (2). In response to the non-personalized generation of the candidate list of items, the recommendation system 106 may pass the candidate list to the candidate ranker 110 to be ranked in order to personalize the list to the particular user.

To personalize the candidate list, the recommendation system 106 may access historical data store 116. Historical data store 116 represents information personalized to a user, such as by corresponding to a user’s behavior, trend, patterns, deviations, actions. Historical data store 116 may include any information collected about a user interacting with the frontend 114. As such, at (4), the recommendation system 106 or the candidate ranker 108 may obtain historical data store 116. As described with reference to FIG. 1, the historical data store 116 includes any information collected about a user interacting with the frontend 114. In some embodiments, historical data store 116 may include a log of user activity with various items associated with the frontend 114. In some embodiments, the historical data store 116 comprises historical items. For example, the historical data store 116 may indicate one or more historical items that a user has previously interacted with (e.g., viewed, clicked, purchased, booked, rented). In some embodiments, historical data store 116 indicating historical items may include any information related to a user’s interaction with various items in the frontend 114, such as a list of properties interacted with, timestamps, click counts, click locations, time spent viewing each item, search strings, number of sessions, etc. The recommendation system 106 (or candidate ranker 108) may obtain the historical data store 116 via network 122.

In some embodiments, historical items are associated with locations in an embedding space, and may be represented by a vector to be stored in the item vector data store 120. As described herein, the embedding space may refer to a space that contains item embeddings, represented by vectors, in such a way to spatially represent the relationships among embeddings. For example, historical items that are similar (e.g., similar location, similar price, similar rating) may be represented in the embedding space at locations that are proximate to each other. On the other hand, historical items that are dissimilar may be represented in the embedding space at locations that are distant from each other. As such, historical data store 116 may include historical items that a user has interacted with and associated locations within the embedding space. Historical data store 116 may represent a user’s journey or history with respect to items in the item vector data store 120.

Over the course of a single session or multiple sessions, a user may interact with multiple historical items. To consolidate the historical items (e.g., historical data) into a representation of a user’s personalized interest, the candidate ranker 110 may determine an average of the historical data. Accordingly, at (5), the candidate ranker 110 may determine a centroid corresponding to an average of the locations associated with the historical items.

To determine a centroid, the candidate ranker 110 may determine a number of historical items to be used in calculating the centroid. The historical items may be chosen according to certain criteria, such as a time interval, a predetermined number of items, etc. For example, the candidate ranker 110 may take into account the previous five historical items that a user has interacted with in the current session. In another example, the candidate ranker 110 may reference all historical items that a user has interacted with in the past ten minutes. In some embodiments, the candidate ranker takes into account the reference item in determination of the centroid. The candidate ranker 110 may determine multiple centroids to capture the user’s interest based on the historical items. For example, the candidate ranker 110 may determine a first centroid that takes into account the historical items that a user has interacted with in the past five minutes and a second centroid that takes into account the historical items that a user has interacted with in the past 10 minutes.

Once the candidate ranker 110 determines a number of historical items (e.g., historical items that are interacted with over a certain time interval), the candidate ranker 110 may determine a centroid corresponding to the average location of the items within the embedding space. The candidate ranker 110 may also take into account the reference item 202 in the centroid determination. A centroid may refer to a geometric center or a mean position of a number of points. As utilized herein, the centroid may refer to the geometric center of a collection of item embeddings. As such, the centroid may represent the user’s collective personalized interest as represented at a location within the embedding space.

The candidate ranker 110 may further utilize calculated centroids to determine features or information to convey a user’s personalized interest in ranking candidate items. Specifically, the candidate ranker 110 may calculate a distance between a centroid and other locations within the embedding space to convey a user’s personalized interest in relation to the candidate items. For example, the candidate ranker 110 may determine or calculate a distance between a centroid and each item of the candidate list. This process may indicate which item of the candidate list is “closest” to an average of the user’s personalized interest, represented by the centroid. Similarly, this calculation may indicate which item of the candidate list is furthest from the average of the user’s personalized interest, represented by the centroid. The candidate ranker 110 may also utilize the centroid in other calculations, such as the difference between the centroid and the reference item 202.

Distance calculations performed by the candidate ranker 110 and other information pertaining to the user’s personalized interest may be included as input into models configured to rank the candidate list of items. For example, non-centroid-based information may be considered relevant to a user’s personalized interest. This may include information related to search parameters (e.g., price minimum/maximum, number of guests), previous bookings, and the like. Any feature relevant to user’s personalized interest may be utilized as input into the models for personalizing the ranking. Accordingly, at (6), the candidate ranker 110 may process the candidate list of items using a machine learning model, such as model data store 118. The candidate ranker 110 may input the candidate list of items, personalized information (such as distance calculations), and other features into the model data store 118 configured to output a ranked list of the candidate items. In some examples, the rankings of individual items in the candidate list may be ranked at least in part on the distances between each individual item and the centroid. Additionally, or alternatively, the rankings of individual items in the candidate list may be ranked at least in part on the distance between the centroid and the reference item. In addition, the rankings of candidate items within the ranked list may be based at least partly on contextual information, such as user location, a device type, a query-related feature, or information relating to a reference item associated with the user. The model data store 118 may take into account a variety of factors, each related to the user’s personalized interest. In doing so, the candidate ranker 110 may, via the model data store 118, generate a ranked list of items which have been ranked in order to personalize that list to the particular user.

At (7), an indication of at least one of the candidate items selected according to the ranked list may be output by the recommendation system 106. For example, the recommendation system 106 may transmit a subset of the ranked items to be displayed in order in the frontend 116 (e.g., on the webpage corresponding to the reference item 202). In some examples, the subset of ranked items may include N items, such as the top ten ranked items, top five items, and the like.

FIG. 2B is an example data flow process 200 in which the candidate ranker of the recommendation system may be trained, according to various aspects of the present disclosure. Model(s) accessed by the candidate ranker 110 of the recommendation system 106 may be trained prior or during inference processes outlined herein (e.g., item recommendation and ranking). Specifically, models utilized by the recommendation system may be trained such that the models may be configured to output a ranked set of items based at least in part on centroid distances (e.g., the distance between individual candidate items and the centroid).

At (1), training data may be input into the candidate ranker 110. Training data 302 may consist of historical data, contextual data, or property information, and the like. For example, training data 302 may include sample sessions of a user utilizing frontend 114 to view various properties that end with the user booking a particular property. This may include a specific path of properties that a user has viewed before booking one of the properties. Training data may include clickstream or other user data sourced from the frontend 114 over a period of time (e.g., three months). In addition, training data 302 may include sessions that end with a successful booking of a property. This training data 302 may be input into the candidate ranker 110 to train the model to predict which properties (items) that a user might be interested in viewing and eventually booking.

At (2), the candidate ranker 110 may, based on past user interaction data, determine a centroid. As noted herein, the candidate ranker 110 may calculate a centroid based on the past user interaction data, such as included within the training data 302, which may contain candidate lists, historical items, and the like. Training data 302 may include data from multiple sessions, wherein each session includes click data within that session. In some embodiments, the training data 302 includes click data within a specific session. Similar to processes described herein, the candidate ranker 110 may calculate a distance between a centroid and other locations within the embedding space to convey a user’s personalized interest in relation to the training data (candidate items). For example, the candidate ranker 110 may determine or calculate a distance between a centroid and each item of a sample candidate list.

At (3), calculated distances from the training data 302 and sample candidate lists may be input into the model (of model data store 118) for training. In response to the input of the calculated distances and sample candidate list, the model may output a list of ranked items 210 at (4).

At (5), the model (of model data store 118) may be updated based on the output list of ranked items. For example, the output list of ranked items may be compared to ground truth data to determine whether the model was able to output a correctly ranked list of items. The model may be updated based on the comparison between the ranked list of items (e.g., prediction) and the ground truth data (e.g., using a loss function). This process may train the model(s) accessed by the candidate ranker 110 to predict items that will likely be purchased, based on the user’s historical data (e.g., items previously viewed).

The training processes described herein may be repeated with various types of training data and distance calculations. This process may train the model accessed by the candidate ranker 110 to infer items that are likely to be purchased by the user, based on the user’s personal interest.

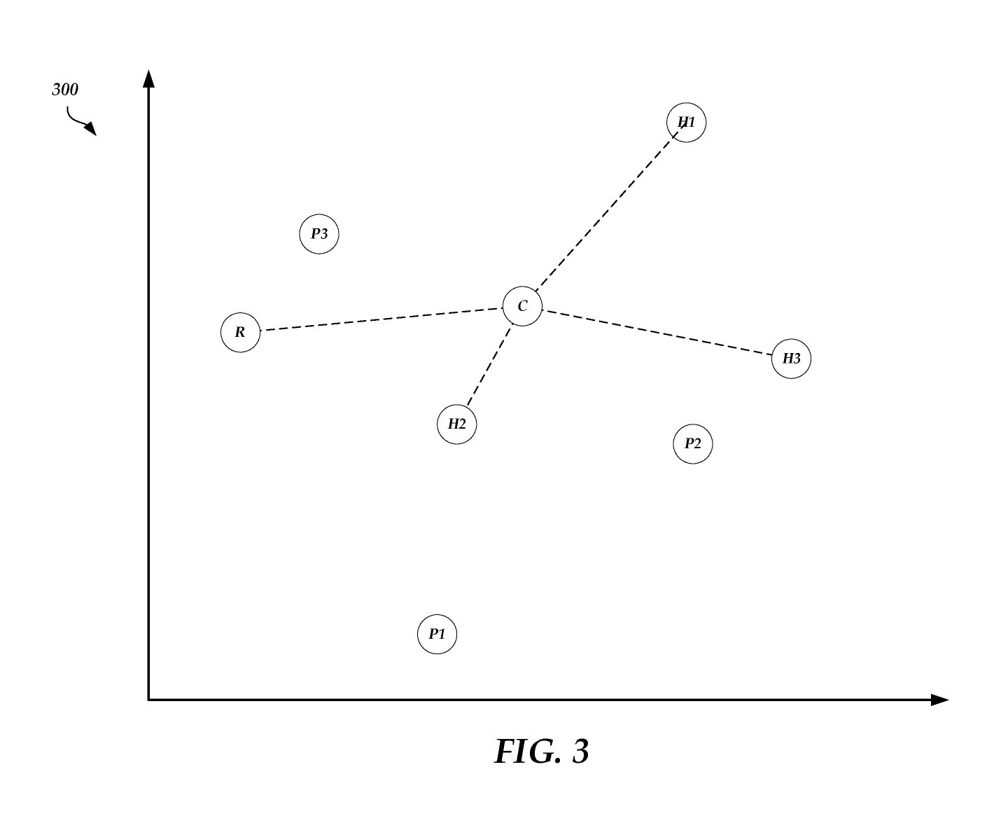

FIG. 3 illustrates a graphical representation of an embedding space 300 in which centroid determination may be executed by the recommendation system 106 (or the candidate ranker 110), according to various aspects of the present disclosure. Embedding space 300 may illustrate the relative locations of items stored in the item vector data store 120. In FIG. 3, embedding space 300 is illustratively depicted as two-dimensional. In practice, embedding space 300, a higher number of dimensions may be used. For example, the embedding space 300 may include hundreds or thousands of dimensions.

The reference item is shown in the embedding space 300 as R. As noted herein, the reference item may be any item related to the travel booking system 104 that is available for a user to view, book, rent, purchase, etc., such as via the frontend 114 (e.g., travel-booking website). In addition, R may be an item that a user is currently viewing in the frontend 114, such as by viewing a webpage corresponding to R’s listing and information.

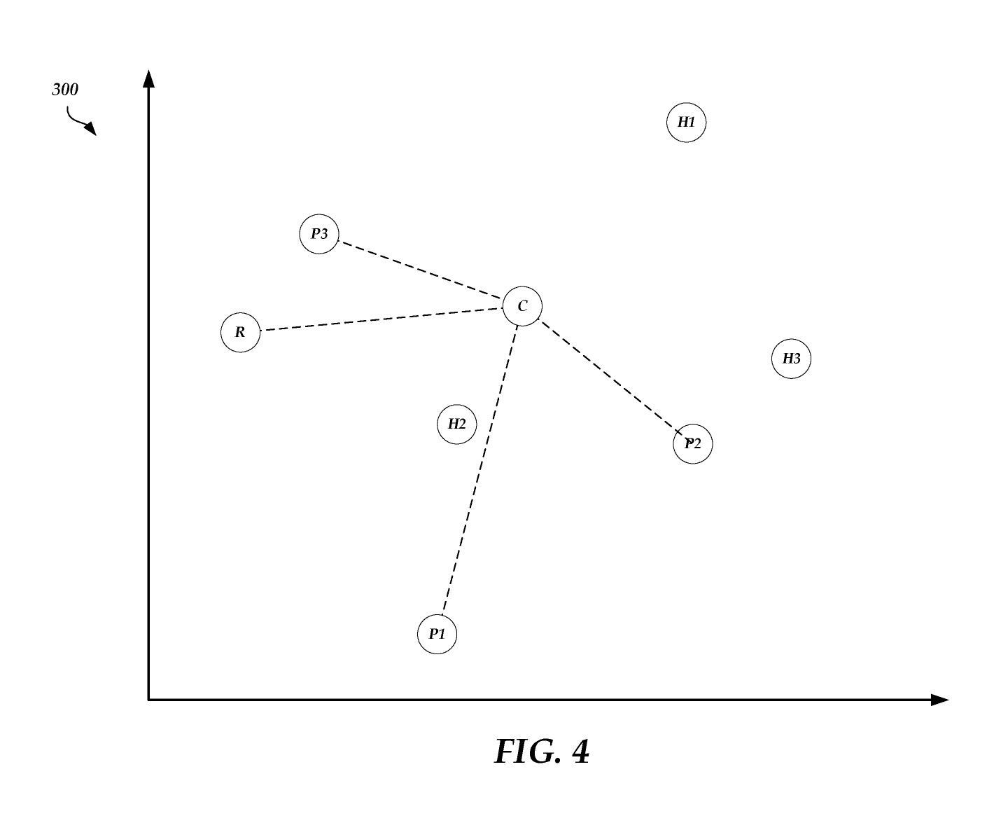

Historical items are shown in the embedding space as H1, H2, and H3. Each historical item represents a different property that a user has previously interacted with (e.g., has clicked on), and may be stored in the historical data store 116. For example, H1, H2, and H3 may represent properties that a user was previously viewing before viewing R within the past ten minutes. As noted herein, the location of each historical item within the embedding space 300 may indicate a spatially relative relationship between the historical item and the other historical items. For example, historical items that are similar (e.g., similar location, similar price, similar rating) may be represented in the embedding space 300 at locations that are proximate to one another. On the other hand, historical items that are dissimilar may be represented in the embedding space at locations that are distant from each other. As shown in FIG. 4, historical items H1, H2, and H3 may be located somewhat proximate to each other. In some examples, H1, H2, and H3 may have a unifying characteristic indicating locations in the embedding space 300 that are proximate to each other. For example, H1, H2, and H3 may be items that have been recently viewed by the user in the past session. In another example, H1, H2, and H3 may be items that are all located within the same city, or have the same rating, and the like.

In addition, candidate items of the candidate list generated by the candidate generator 108 are shown in the embedding space 300 as P1, P2, and P3. Candidate items P1, P2, and P3 may be generated by candidate generator 108 according to processes discussed herein.

The candidate ranker 110 may determine a centroid corresponding to the average location of the historical items and the reference item within the embedding space 300. The centroid may refer to the geometric center of the historical items and the reference item, as shown by the dotted lines in FIG. 4 leading from H1, H2, H3, and R to the centroid C. The candidate ranker 110 may determine a location within the embedding space 300 corresponding to centroid C. Centroid C may represent a user’s collective personalized interest with respect to historical items H1, H2, H3, and R.

FIG. 4 illustrates a graphical representation of an embedding space 300 in which distance calculations utilizing a determined centroid may be executed by the recommendation system 106 (or the candidate ranker 110), according to various aspects of the present disclosure. Embedding space 300 may illustrate the relative locations of items stored in the item vector data store 120.

As described with reference to FIG. 3, the candidate ranker 110 may determine a centroid C associated with historical items H1, H2, H3, and reference item R. Centroid C may represent a user’s collective personalized interest with respect to historical items H1, H2, H3, and reference item R. In addition, candidate items of the candidate list generated by the candidate generator 108 are shown in the embedding space 300 as P1, P2, and P3. Candidate items P1, P2, and P3 may be generated by candidate generator 108 according to processes discussed herein.

In response to the determination of centroid C, the candidate ranker 110 may further calculate distances between the centroid C and various locations within the embedding space 300 to represent information conveying a user’s personalized interest. For example, the candidate ranker 110 may calculate a distance between a centroid and other locations within the embedding space to convey a user’s personalized interest in relation to the candidate items. This information can be later accessed by the model data store 118 to personalize the ranked list of items.

As shown in FIG. 4 as dotted lines, the candidate ranker 110 may determine a distance between centroid C and each item of the candidate list P1, P2, and P3. In some embodiments, the distance may be a cosine distance. The candidate ranker 110 may store the distances in a data store. This process may indicate which item of the candidate list is “closest” to an average of the user’s personalized interest, represented by the centroid C. For example, it appears that candidate item P2 is the closest to centroid C, with P3 as the next closest, and P1 as the furthest from centroid C.

Additionally, or alternatively, the candidate ranker 110 may determine a distance between the centroid C and the reference item R. This distance may indicate a degree to which a user’s focus has shifted between the reference item and a determined personalized interest (based on the historical items). In some embodiments, the distance may be a cosine distance.

Similarly, this calculation may indicate which item of the candidate list is furthest from the average of the user’s personalized interest, represented by the centroid. The candidate ranker 110 may also utilize the centroid in other calculations, such as the difference between the centroid and the reference item 202.

The candidate ranker 110 may determine various other types of distance calculations based on the location of items within the embedding space 300. Distance calculations performed and stored by the candidate ranker 110 may be included as input into models configured to rank the candidate list of items.

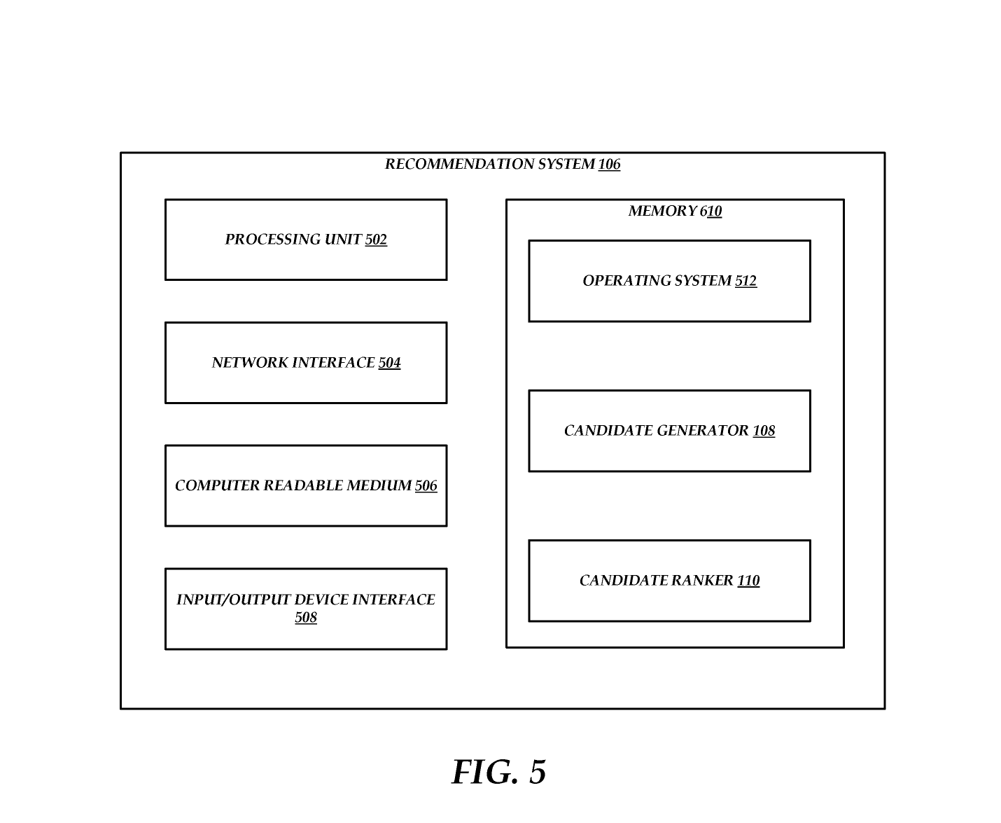

FIG. 5 is a block diagram illustrating components of an example computing system that can be used to implement the various systems and methods described herein.

The general architecture of the system depicted in FIG. 5 includes an arrangement of computer hardware and software that may be used to implement aspects of the present disclosure. The hardware may be implemented on physical electronic devices, as discussed in greater detail below. The system may include many more (or fewer) elements than those shown in FIG. 5. It is not necessary, however, that all of these generally conventional elements be shown in order to provide an enabling disclosure. Additionally, the general architecture illustrated in FIG. 5 may be used to implement one or more of the other components illustrated in FIG. 1. As illustrated, the system includes a processing unit 502, a network interface 504, a computer-readable medium drive 506, and an input/output device interface 506, and memory 510, all of which may communicate with one another by way of a communication bus.

The network interface 504 may provide connectivity to one or more networks or computing systems. The processing unit 502 may thus receive information and instructions from other computing systems or services via the network. The processing unit 502 may also communicate to and from memory 510 and further provide output information for an optional display (not shown) via the input/output device interface 508. The input/output device interface 508 may also accept input from an optional input device (not shown).

The memory 510 may contain computer program instructions (grouped as units in some embodiments) that the processing unit 502 executes in order to implement one or more aspects of the present disclosure, along with data used to facilitate or support such execution. While shown in FIG. 5 as a single set of memory 510, memory 510 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

The memory 510 may store an operating system 512 that provides computer program instructions for use by the processing unit 502 in the general administration and operation of the recommendation system 106. The memory 510 may further include computer program instructions and other information for implementing aspects of the present disclosure. For example, in one embodiment, the memory 510 includes the candidate generator 108 and the candidate ranker 110.

The candidate generator 108 may represent code executable to generate a list of non-personalized candidate items for recommendation to a user based on a reference item 202. The candidate ranker 110 may represent code executable to rank the list of candidate items in order to personalize that list to a particular user.

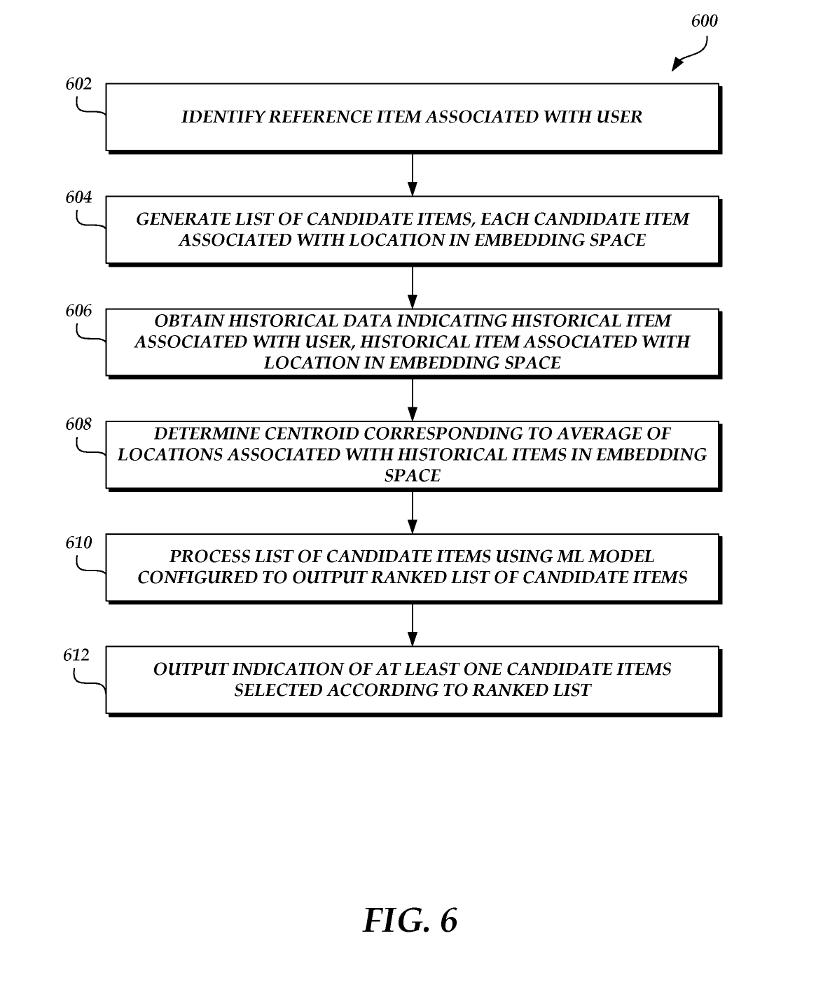

The system of FIG. 5 is one illustrative configuration of such a device, of which others are possible. For example, while shown as a single device, a system may in some embodiments be implemented as a logical device hosted by multiple physical host devices. In other embodiments, the system may be implemented as one or more virtual devices executing on a physical computing device. While described in FIG. 6 as a recommendation system 106, similar components may be utilized in some embodiments to implement other devices shown in the recommendation system 106 of FIG. 5.

FIG. 6 is flow diagram showing an example routine 600 for providing personalized ranked recommendations to a user, according to various aspects of the present disclosure. Routine 600 may be executed by the recommendation system 106 and various components of the travel booking system 104. Specifically, the routine 600 may be executed by a processor, such as the processing unit 502, shown in FIG. 5.

At block 602, a reference item, such as reference item 202, associated with a user is identified. The reference item 202 may include any item associated with the travel booking system 104. For example, the reference item 202 may include a property (e.g., hotel, rental, condo, resort, spa, chalet, cabin, villa), a car, a flight, an activity, a package, or any other listing. The reference item 202 may be any item related to a travel-booking website that is available for a user to view, book, rent, purchase, etc. in the frontend 114. The reference item 202 may be associated with a location within an embedding space (e.g., embedding space 300), and stored as a vector within the item vector data store 120.

The processes carried out by the recommendation system 106 may be triggered by an action of a user of the frontend 114. A trigger event may include when a user, via the frontend 114, clicks or accesses the reference item 202. For example, the user may search for a particular item via a search function in the frontend 114 (e.g., hotels in Palermo, Sicily). Upon viewing the results, the user may then select one particular property, which may be the reference item 202. This event may trigger the recommendation system 106 to access, obtain, or otherwise identify the reference item 202.

At block 604, a candidate list of items is generated. Each candidate item may be associated with a location in an embedding space, such as embedding space 300. To generate the candidate list of items, the candidate generator 106 may access all possible items, such as items stored as vectors in the item vector data store 120. The item vector data store 204 may store all possible candidate items, and may include any item associated with the travel booking system 104. For example, the item vector data store may store a listing or representation of a property (e.g., hotel, rental, condo, resort, spa, chalet, cabin, villa), a car, a flight, an activity, a package, or any other listing that is associated with the travel booking system 104.

The candidate generator 108 may, at block 604, narrow down a set of millions of items stored in the item vector data store 120 to a list of hundreds of candidate items, for example. The candidate generator 108 may access any algorithm, program, generative language model, AI model (such as a ML model, deep learning model, neural network, etc.) configured to generate a candidate list of items. For example, the candidate generator 108 may access a collaborative filtering model, a semantic embedding model, a two-tower model, Word2Vec model, and the like. In some embodiments, the candidate generator 108 may access a hybrid model that combines the processes of any of the above-referenced models above. The candidate generator 108 may generate any number of candidate items to be included in the list of candidate items.

In some embodiments, at block 604, the processes carried out by the candidate generator 106 may be performed offline. For example, the candidate generator 108 may utilize a lookup table to determine the list of candidate of items. The candidate generator 108 may operate offline to preserve computing resources and to reduce latency. In addition, any offline lookup tables may be refreshed periodically. For example, for a certain reference item 202, the candidate generator 106 may access a lookup table to retrieve a number of candidate items that correspond to the reference item 202 that have already been curated by a collaborative filtering process carried out online (e.g., monthly). This approach allows the candidate generator 108 to quickly retrieve a manageable set of candidate items related to the reference item 202 to be ranked by the candidate ranker 110. In response to the generation of the list of candidate items, at block 604, the candidate generator 108 may input the list of candidate items to the candidate ranker 110.

As noted herein, embodiments disclosure herein provide for a two-part recommendation system, whereby a non-personalized item-to-candidate item list is generated without personalization (e.g., as a periodic, non-real-time process) by the candidate generator 108 at block 604. In response to the non-personalized generation of the candidate list of items, the recommendation system 106 may pass the candidate list to the candidate ranker 110to be ranked in order to personalize the list to the particular user.

At block 606, historical data is obtained. In some examples, historical data may indicate one or more historical items associated with the user. Historical data store 116 represents information personalized to a user, such as by corresponding to a user’s behavior, trend, patterns, deviations, actions. Historical data store 116 may include any information collected about a user interacting with the frontend 114. The historical items may be obtained according to certain criteria, such as a time interval, a predetermined number of items, etc. For example, the candidate ranker 110 may take into account the previous N historical items (e.g., five, ten, 20) that a user has interacted with in the current session. In some embodiments, the candidate ranker 110 may obtain historical items from multiple previous sessions. In another example, the candidate ranker 110 may reference all historical items that a user has interacted with in the past ten minutes. In some embodiments, the candidate ranker takes into account the reference item in determination of the centroid.

As described with reference to FIG. 1, the historical data store 116 includes any information collected about a user interacting with the frontend 114. In some embodiments, historical data store 116 may include a log of user activity with various items associated with the frontend 114. In some embodiments, the historical data store 116 comprises historical items. For example, the historical data store 116 may indicate one or more historical items that a user has previously interacted with (e.g., viewed, clicked, purchased, booked, rented). In some embodiments, historical data store 116 indicating historical items may include any information related to a user’s interaction with various items in the frontend 114, such as a list of properties interacted with, timestamps, click counts, click locations, time spent viewing each item, search strings, number of sessions, etc. The recommendation system 106 (or candidate ranker 108) may obtain the historical data store 116 via network 122.

In some embodiments, historical items are associated with locations in an embedding space, and may be represented by a vector to be stored in the item vector data store 120. In some embodiments, the location (or embedding) of a historical item within the embedding space 300 may represent a combination of embeddings. Various aspects relating to a single item (or property) may be combined to form an enriched embedding of the item, such as a one-hot encoding of the clicked item by the user (such as within the same session), associated amenities, and geographical location of the item. Each one of these may be represented in the embedding space as a separate embedding: a click embedding, an amenity embedding, and a geographical embedding. Each of these features of the same item may be embedded separately within the embedding space and then concatenated such that the location of the item includes the feature information. Once combined, the location associated with the historical item in the embedding space may be an average corresponding to each of combined embeddings. Each historical item accessed by the recommendation system 106 may be enriched, and may represent any other combination of features or information.

Historical data store 116 may represent a user’s journey or history with respect to items in the item vector data store 120. For example, a user may click through various items in a single or multiple sessions. Accordingly, each historical item may be located through the embedding space depending on their similarity, or other features. For example, historical items that are similar (e.g., similar location, similar price, similar rating) may be represented in the embedding space at locations that are proximate to each other. On the other hand, historical items that are dissimilar may be represented in the embedding space at locations that are distant from each other. As such, historical data store 116 may include historical items that a user has interacted with and associated locations within the embedding space.

At block 608, a centroid corresponding to an average of locations associated with the one or more historical items in the embedding space is determined. In some embodiments, the candidate ranker takes into account the reference item in determination of the centroid.

The candidate ranker 110 may determine a centroid corresponding to the average location of the historical items and reference item within the embedding space 300. As described throughout, a centroid may refer to a geometric center or a mean position of a number of points. In addition, the centroid may refer to the geometric center of a collection of item embeddings, such as the historical items and the reference item. As such, the centroid may represent the user’s collective personalized interest as represented at a location within the embedding space.

At block 610, the list of candidate items is processed using an ML model. The ML model may be configured to output a ranked list of the candidate items. In addition, the rankings of individual items may be based at least partly on a distance between the individual items and the centroid. The candidate ranker 110 may input the candidate list of items, personalized information (such as distance calculations), and other features into the model data store 118 configured to output a ranked list of the candidate items.

The ML model, such as model data store 118, include any algorithm, program, generative language model, AI model, deep learning model, neural network, etc. Model data store 118 may be accessed by any component of the travel booking system 104, such as the recommendation system 106. The recommendation system 106 (or components of the recommendation system 106). The model data store 118 may be stored in a database or data store in the travel booking system 104 and accessible via the network 122. In some embodiments, the ML model, such as model data store 118, is a gradient boosting model.

In some examples, the rankings of individual items in the candidate list may be ranked at least in part on the distances between each individual item and the centroid. Additionally, or alternatively, the rankings of individual items in the candidate list may be ranked at least in part on the distance between the centroid and the reference item. The model data store 118 may take into account a variety of factors, each related to the user’s personalized interest. In doing so, the candidate ranker 110 may, via the model data store 118, generate a ranked list of items which have been ranked in order to personalize that list to the particular user.

At block 612, an indication of at least one of the candidate items selected according to the ranked list is output to the user. For example, the recommendation system 106 may transmit a subset of the ranked items to be displayed in order in the frontend 116 (e.g., on the webpage corresponding to the reference item 202).

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system, comprising:
a computer-readable storage medium storing program instructions; and
one or more processors configured to execute the program instructions to cause the system to:
identify a reference item associated with a user;
generate, based on the reference item, a list of candidate items, wherein each candidate item is associated with a location in an embedding space;
obtain historical data indicating one or more historical items associated with the user, wherein the one or more historical items are associated with locations in the embedding space;
determine a centroid corresponding to an average of locations associated with the one or more historical items in the embedding space;
process the list of candidate items using a machine learning model configured to output a ranked list of the candidate items, wherein rankings of each candidate item within the ranked list is based at least partly on a distance between the candidate items and the centroid; and
output, to the user, an indication of at least one of the candidate items selected according to the ranked list.

2. The system of claim 1, wherein the one or more historical items comprise items in the embedding space with which the user has previously interacted.

3. The system of claim 1, wherein the location of the one or more historical items represents a combination of a click embedding, an amenity embedding, and a geographical embedding.

4. The system of claim 1, wherein the rankings of candidate items within the ranked list is based at least partly on a distance between the reference item and the centroid.

5. The system of claim 1, wherein the rankings of candidate items within the ranked list is based at least partly on at least one of a user location, a device type, a query-related feature, or information relating to the reference item.

6. The system of claim 1, wherein the machine learning model includes a gradient boosting model.

7. The system of claim 1, wherein the list of candidate items is generated by a collaborative filtering model.

8. A method, comprising:
generating a list of candidate items, wherein each candidate item is associated with a location in an embedding space;
obtaining historical data indicating one or more historical items associated with a user, wherein the one or more historical items are associated with locations in the embedding space;
determining a centroid corresponding to an average of locations associated with the one or more historical items in the embedding space;
processing the list of candidate items using a machine learning model configured to output a ranked list of the candidate items, wherein rankings of each candidate item within the ranked list is based at least partly on a distance between the candidate items and the centroid; and
outputting, to the user, an indication of at least one of the candidate items selected according to the ranked list.

9. The method of claim 8, wherein the one or more historical items comprise items in the embedding space that the user has previously interacted with.

10. The method of claim 8, wherein the location of the one or more historical items represents a combination of a click embedding, an amenity embedding, and a geographical embedding.

11. The method of claim 8, wherein the rankings of candidate items within the ranked list is based at least partly on a distance between the centroid and a reference item associated with the user.

12. The method of claim 8, wherein the rankings of candidate items within the ranked list is based at least partly on at least one of a user location, a device type, a query-related feature, or information relating to a reference item associated with the user.

13. The method of claim 8, wherein the machine learning model includes a gradient boosting model.

14. The method of claim 8, wherein the list of candidate items is generated by a collaborative filtering model.

15. One or more non-transitory computer-readable media storing computer-executable instructions that, when executed by a processor of a computing device, cause the computing device to at least:
generate a list of candidate items, wherein each candidate item is associated with a location in an embedding space;
obtain historical data indicating one or more historical items associated with a user, wherein the one or more historical items are associated with locations in the embedding space;
determine a centroid corresponding to an average of locations associated with the one or more historical items in the embedding space; and
process the list of candidate items using a machine learning model configured to output a ranked list of the candidate items, wherein rankings of each candidate item within the ranked list is based at least partly on a distance between the candidate items and the centroid.

16. The one or more non-transitory computer-readable media of claim 15, wherein the processor is further configured to output, to the user, an indication of at least one of the candidate items selected according to the ranked list.

17. The one or more non-transitory computer-readable media of claim 15, wherein the one or more historical items comprise items in the embedding space that the user has previously interacted with.

18. The one or more non-transitory computer-readable media of claim 15, wherein the rankings of candidate items within the ranked list is based at least partly on a distance between the centroid and a reference item associated with the user.

19. The one or more non-transitory computer-readable media of claim 15, wherein the rankings of candidate items within the ranked list is based at least partly on at least one of a user location, a device type, a query-related feature, or information relating to a reference item associated with the user.

20. The one or more non-transitory computer-readable media of claim 15, wherein the machine learning model includes a gradient boosting model.
